(19) United States
(12) Patent Application Publication
(10) Pub. No.: US 2005/0020409 A1
(43) Pub. Date: Jan. 27, 2005

(54) Physical rehabilitation training and education device

(75) Inventors: Satoru Hayamizu, Gifu-shi (JP); Haruhisa Kawasaki, Gifu-shi (JP); Yutaka Nishimoto, Gifu-shi (JP); Satoshi Ito, Gifu-shi (JP)

Correspondence Address: APEX JURIS, PLLC, 13194 EDGEWATER LANE NORTHEAST, SEATTLE, WA, 98125, US

(73) Assignee: Gifu University, Gifu-shi (JP)

(21) Appl. No.: 10/665,902

(22) Filed: Sep. 18, 2003

(30) Foreign Application Priority Data
Jul. 22, 2003 (JP) 2003-277308

(51) Int. Cl. G09B 23/28; A63B 22/00; A63B 71/00

(52) U.S. Cl. 482/51; 434/262

(57) ABSTRACT

The rehabilitation training device 1 reproduces the symptoms of a simulated joint condition such as the dynamic contracture that occurs in the joint, and allows the trainee to perform the rehabilitation technique. The rehabilitation training device mainly comprises the model human body with the movable model joint which has joint sections such as the upper extremity joint section and is capable of reproducing the movement of the actual human joint and the process controlling section comprising the motion controlling section controlling the movement of the movable model joint; the memory section storing and recording the disease condition information which is capable of reproducing the condition of the joint with such as the dynamic contracture; the disease condition reproduction section displaying the simulated disease condition of the movable model joint by the disease condition information and the motion controlling section; the section for obtaining the rehabilitation technique information obtaining the rehabilitation technique information from the changing movable model joint through the performance of the rehabilitation technique; and the improvement controlling section capable of improving the symptom of the simulated disease condition displayed on the movable model joint based on the rehabilitation technique information.

### FIELD OF THE INVENTION

This invention relates to a physical rehabilitation training and education device and more particularly to a physical rehabilitation training and education device which is utilized for acquisition and training of the rehabilitation technique of performing a medical treatment as an external force moves a joint so as to prevent joint contracture and to rehabilitate functions thereof.

### BACKGROUND OF THE INVENTION

Conventionally, rehabilitation has been performed for the purpose of rehabilitating body functions and preventing advance of symptom for a patient with hemiplegia due to apoplectic stroke. At this rehabilitation stage, the joint of the patient is moved by an external force to prevent joint contracture and to rehabilitate functions of the nerve system.

In the above-conventional rehabilitation, a conventional rehabilitation device is designed to apply an external force to move the joint in order to reduce the burden of the patient and the manpower of a physiotherapist and an occupational therapist assisting the patient. Such a device, e.g., devices disclosed in the Japanese Provisional Patent Publication No. 2000-288045 and No. 2002-272795, have been used at rehabilitation training facilities.

If the conventional rehabilitation device applies the external force to move the joint to perform the rehabilitation, for example, dynamic contracture, depending upon the degree, may force the joint to make an excessive movement beyond a movable range. In that case, because many of the conventional rehabilitation devices are configured to allow the repetitive movement within the predetermined movable range, the joint is damaged due to the excessive movement beyond the movable range. Accordingly, the rehabilitation causes damage to the body, thereby delaying the recovery of the body functions.

Instead of utilizing the above-conventional rehabilitation devices, a therapist (hereinafter therapist or trainee) such as a physiotherapist and an occupational therapist may assist the patient to perform the rehabilitation. In such a case, as the therapist ascertains the stiffness condition of the patient joint as appropriate, the rehabilitation is performed while the therapist adjusts the force to be applied on the joint in consideration of the stiffness condition. Because of the proper assistance of the therapist, the patient receives the rehabilitation technique with the appropriate force, and recovery of the motion function becomes accelerated.

However, as a matter of fact, in the case of the therapists performing the rehabilitation technique for rehabilitation to the patient, skills and experiences of the therapist play a significant role in an effective recovery of the motion function. That is, the recovery of the motion function greatly depends upon whether the trainee is a professional therapist who is highly skilled and experienced, a standard trainee who is skilled and experienced to some degrees, or an amateur trainee who has less or no skills and experiences.

In the case where the rehabilitation is performed to recover the motion function, the contracture of the respective joint severely restricts the motion range of the joint, and the deformity of the joint varies depending upon symptom types. Accordingly, ascertaining the symptom appearing on the joint of the patient, i.e., attending to see whether the rehabilitation technique gives the patent any excessive pain, the therapist needs to perform the rehabilitation as gradually expanding the motion range of the joint.

However, the therapist without sufficient experience has difficulty in accurately judging the symptom of the joint and often applies an excessive force at an earliest stage of the rehabilitation, thereby resulting in damaging the body and giving the patient pain and discomforting feeling. In another case, the therapist without sufficient experience is too concerned about the possibility of giving an adverse effect, as stated above, and tends to apply an insufficient force throughout the entire process, thereby failing to provide effective rehabilitation. In addition, other factors such as moving directions of the joint may vary between the professional therapist with excellent rehabilitation skills and the amateur therapist. Further, even if the therapist is in an intermediate level with experiences and skills to some degrees, there is still a possibility of departing from the fundamental techniques because of the therapist's routinized rehabilitation technique deviating therefrom.

The routinized rehabilitation technique cannot easily be adjusted because the therapist often cannot make an objective evaluation of his or her performance regardless of an objective suggestion from others, thereby further performing the rehabilitation while deviating from the fundamental techniques.

In consideration of the above reality and existing problems, this invention is to provide a physical rehabilitation training and education device that improves the rehabilitation technique skills of the therapist for effective recovery of the symptom such as dynamic contracture while offering appropriate training and education suitable for the symptom of the joint problem. The physical rehabilitation training and education device of this invention also provides an opportunity to give objective evaluation with respect to the rehabilitation technique of the trainee.

### SUMMARY OF THE INVENTION

This invention is to resolve the above-identified problems, and the physical rehabilitation training and education device of this invention comprise a model human body imitating a human body with one or more movable model joints imitating movement of a real human joint; a motion controller that controls movement of the movable model joint; a joint condition information memory system for storing information relating to the joint condition of the human joint; and a joint condition display that shows simulated symptoms of the joint condition of the movable model joint while the motion controller controlling the motion controller based on the stored joint condition information.

Accordingly, the physical rehabilitation training and education device of this invention is configured with the model human body with the movable model joint which is capable of making an equivalent movement to an actual human joint (for example, an articulation humeri, i.e., a shoulder joint, of the upper extremity section and an articulatio coxae, i.e., a hip joint, of a lower extremity section). The movable model joint is able to duplicate/reproduce and display the symptom as it appeared on the human joint based on the condition information stored in the condition information memory. Accordingly, a trainee, such as a medical student, who utilizes the model human body, due to the movable model joint with the condition displayed, experiences the simulated symptom such as the dynamic contracture of the joint.

Generally, the human joint is capable of making a smooth or an active movement, and the movement of which is severely restricted due to a various factors based on the joint condition. For instance, if the patient has hemiplegia at the right or left side of the human body as an aftereffect to the patient after cerebral apoplexy, the respective joint, e.g., the upper and lower extremity sections, at the hemiplegia side of the body impairing the motion function, is constrained to be in the same postural position for a long period of time, thereby damaging characteristics of the joint and muscle such as elasticity and stretchability. The physical rehabilitation training and education device duplicates and reproduces the symptom based on the information of the condition of the body impaired with such characteristics.

Hence, the trainee who wishes to learn the rehabilitation technique is able to touch the movable model joint reproducing the simulated condition prior to the training, which enables the trainee to experience and to learn about the simulated conditions, like the stiffness of the joint and the degree of the joint deformation.

In addition to the above-structures, the physical rehabilitation training and education device of this invention may further comprise a rehabilitation technique information system that obtains rehabilitation technique information when rehabilitation is performed by a trainee while the trainee is applying an external repetitive force to the movable model joint with a joint condition, the joint condition is displayed thereon by the joint condition displayer, the system measures a rate of change of the joint condition based on an angle, a position, and a motion speed of the movable model joint due to the external repetitive force being applied thereon by the trainee; and a joint condition improvement controller that is capable of displaying a simulated diagnosis of a rehabilitating symptom regarding the movable model joint and is capable of controlling the progress of the simulated condition based on the rehabilitation technique information obtained from the trainee as the trainee performs the rehabilitation technique on the movable model joint.

As such, the physical rehabilitation training and education device of this invention offers an opportunity to perform rehabilitation technique on the movable model joint of the model human body with reproduced, simulated conditions just like performing the rehabilitation technique on an actual human body. Normally, when practicing the rehabilitation, the therapist applies the external repetitive force to the joint of the patient so as to expand and contract the joint and dilatation of the surrounding muscle. The therapist may work to relax the stiff joint, of which the patient alone became unable to move because of hypofunction and to gradually expand the already narrowed motion range of the joint.

In the case where the above-described rehabilitation technique is performed on the movable model joint with the displayed symptom, the physical rehabilitation training and education device of this invention the information of the rehabilitation technique relating to the force to be applied in consideration of the changes in the movable model joint. Then, the physical rehabilitation training and education device provides a procedure taken in the rehabilitation technique performed on the movable model joint, i.e., data regarding a manner of moving or bending the movable model joint, a speed of bending thereof, and a process taken in the rehabilitation technique. Generally, because of the characteristic of human muscle to be known as viscoelastic, repeating the rapid motion of expanding the joint may be absorbed by an elastic effect of the muscle, thereby impairing the effective rehabilitation result. On the other hand, slow and smooth expansion of the same is known to sufficiently provide effective rehabilitation result.

The therapist may perform the rehabilitation on the movable model joint, similar to performing on the actual human joint, and is able to experience the simulated recovery of the symptom from the changes in the condition of the movable model joint. The degree and speed of the recovery of course depends upon factors such as the degree of the force applied during the rehabilitation technique and number of repetitive actions. Prior to the performance of the rehabilitation technique on the actual human body, the therapist can eliminate the anxiety about the rehabilitation and can acquire the appropriate rehabilitation technique utilizing the rehabilitation training and education of this invention. Accordingly, this invention helps the therapist to improve the level of rehabilitation technique and also helps the actual patient to recover the motion function in an early stage in a prompt manner. In addition, this invention allows the patient to be rehabilitated with a safe conscience.

Still further, in addition to the above-structures, the physical rehabilitation training and education device of this invention may be characterized in that the motion controller further comprising: a motion range controller that controls a motion range of the movable model joint; and a motion resistance controller that controls a motion resistance where the reaction force is equivalent to a reaction force against the external repetitive force on the movable model joint.

According to the physical rehabilitation training and education device of this invention, as the rehabilitation is being performed while applying the repetitive force of the rehabilitation technique on the movable model joint with the displayed condition, the device displays the symptom or current status of the improved or rehabilitated condition. The improvement in and increase in mobility of the model joint means, for example, an expansion of the motion range of the stiff movable model joint or a condition that requires a smaller force to rehabilitate the movable model joint (reduction in the motion resistance upon applying the external force). The motion control section has a system or device capable of controlling the above-described motion range and the motion resistance. Accordingly, the motion range of the movable model joint is expanded and the reduction in the motion resistance is controlled, thereby making it possible to display the joint condition ranging from a normal healthy state to a problematic condition.

Still further, in addition to the above-structures, the physical rehabilitation training and education device of this invention further comprises a secondary rehabilitation technique information memory that stores the secondary rehabilitation technique information showing changes in the movable model joint after performing the rehabilitation technique on the human body.

According to the physical rehabilitation training and education device of this invention, for example, information or record of the rehabilitation technique performed by the professional therapist with highly experienced rehabilitation technique obtained through performing on actual patients, is captured and recorded as secondary rehabilitation information. That is, recording and storing of the information of the rehabilitation performed on the actual patients, operations of the motion control section to control the condition and the (condition improvement controller) to ease the symptom in order for the symptoms to become closer to the actual condition or symptom. The therapist therefore is able to experience the practical training through the physical rehabilitation training and education device of this invention.

Still further, in addition to the above-structures, the rehabilitation training education device of this invention further comprises an evaluation criteria information memory system that stores information of evaluation criteria where the trainee is evaluated based on a pre-established criteria for medical treatment classified by one or more levels of rehabilitation technique so as to evaluate the trainee based on the level of rehabilitation technique performed; and an evaluation system that evaluates the level of rehabilitation technique performed by the trainee based on the rehabilitation technique information and the evaluation criteria information for medical treatment.

The physical rehabilitation training and education device of this invention can provide the evaluation of the rehabilitation technique based on the information of the rehabilitation technique performed and the evaluation criteria information. Accordingly, the level of the rehabilitation technique of the therapist may be evaluation and judged in an objective manner.

Still further, in addition to the above-structures, the rehabilitation training education device of this invention is characterized in that the rehabilitation technique information includes trainee attribute data and training history data for the particular trainee performing the rehabilitation technique; and the evaluation system has a system to evaluate any improvement in the level of rehabilitation technique regarding the trainee based on training history data.

The physical rehabilitation training and education device of this invention involves data regarding the attribute of the therapist to identify the particular therapist which includes, for example, name, identification number and data regarding the history of the training. For the therapist with the training experience who has the prior evaluation records showing the rehabilitation technique level judged by the section for evaluating the level of an improvement in the rehabilitation technique, any improvement in the level of the rehabilitation technique for the particular therapist may be evaluated based on the prior evaluation record. That is, repeating the training on the physical rehabilitation training and education device helps to gradually improve the level of the rehabilitation technique of the trainee. Comparing the prior evaluation with the current evaluation makes it possible to improve the level of the rehabilitation technique and therefore allows trainee to see improvement.

Still further, in addition to the above-structures, the rehabilitation training education device of this invention is characterized in that the information of the evaluation criteria for the medical treatment is classified into an amateur level for a beginning trainee, a standard level for a trainee with a predetermined level of skills and experiences, and a professional level for a highly skilled and experienced trainee.

Therefore, according to the physical rehabilitation training and education device of this invention, evaluation standard at least is classified into an entry level for an amateur trainee, an intermediate level for a standard trainee, and an advanced level for a professional trainee. Because of the divided classifications, the trainee can easily recognize and be aware of the level of his own rehabilitation technique. However, the classes are not limited to three, and any appropriate number of classes may be provided as necessary and appropriate.

Still further, in addition to the above-structures, the rehabilitation training education device of this invention is characterized in that the evaluation system further comprises a voice response system to output an audible signal to report a load being applied on the movable model joint based on the rehabilitation technique information.

Accordingly, the physical rehabilitation training and education device of this invention makes it possible to evaluate the rehabilitation technique performed on the model of human body via outputting the audible signal of the evaluation. That is, the voice response system alerts and reports the result of the performance in case that excessive force or load is applied to the movable model joint, which could have caused pain on the actual patients. The therapist therefore can feel how much load need be applied to an affected part of the actual patient through training on the model human body. Furthermore, the voice response means also reports the result of the performance in case that the rehabilitation technique of the movable model joint is appropriate or that the degree and direction of the applied force and the manner of movement are appropriate. The therapist therefore can evaluate his or her performance using the voice report without viewing the display, such as a monitor while performing the rehabilitation technique.

Still further, in addition to the above-structures, the rehabilitation training education device of this invention is characterized in that the movable model joint has at least one of an upper extremity section, a lower extremity section, and a digit section

Therefore, the physical rehabilitation training and education device of this invention allows the therapist to perform the rehabilitation technique training on the upper extremity section, the lower extremity section, and the finger section of the model human body. These three sections most frequently become the subject section (affected section) to be rehabilitated for the recovery of the motion function thereof. Hence, training of the rehabilitation technique on these three sections and improvement of the level of the rehabilitation technique may be sufficient and appropriate for the improvement of the technique and capability of the therapist.

Yet further, in addition to the above-structures, the rehabilitation training education device of this invention is characterized in that the simulated condition of the movable model joint exhibits symptoms of at least one of dynamic contracture, static contracture, stiffness, and joint deformation.

Accordingly, the physical rehabilitation training and education device of this invention gives the opportunity to perform rehabilitation training on the dynamic contracture, the static contracture, the stiffness, and the joint deformation that may possibly occur to the human joint, and the therapist is able to obtain the rehabilitation technique corresponding to the condition of the patient.

The physical rehabilitation training and education device of this invention has an advantage in that the movable model joint reproduces the joint movement of the actual human joint and reproduces the symptom of the simulated condition on the movable model joint, such as the dynamic contracture, thereby allowing the therapist to grasp and recognize the symptom of the condition and experience the simulated recovery of the symptom as performing the rehabilitation technique on the movable model joint.

Further, improvement of the condition and the symptom may be displayed similar to when performing the rehabilitation technique on the actual human body and therefore the therapist may perform the rehabilitation technique training without feeling uncomfortable.

Accordingly, this invention helps to facilitate the improvement of the rehabilitation technique. Further, the therapist may be able to evaluate his or her rehabilitation technique performance, thereby receiving an objective evaluation of the performance.

### BRIEF DESCRIPTION OF THE DRAWINGS

The present invention will now be described, by way of example, with reference to the accompanying drawings, in which:

FIG. 1 is a schematic view of the structure of the rehabilitation training device in the embodiment;

FIG. 2 is a flowchart mainly explaining the functional structure of the process controlling section of the rehabilitation training device;

FIG. 3 is a partial view of the model human body explaining an example of a simulated movement of the movable model joint;

FIG. 4 is a flowchart explaining the process of the process controlling section during the rehabilitation training using the rehabilitation training device;

FIG. 5 is a partial view of the model human body explaining an example of the rehabilitation technique for the upper extremity joint;

FIG. 6 is a partial view of the model human body explaining an example of the rehabilitation technique for articulation coxage and articulation genus of the lower extremity joint;

FIG. 7 is a partial view of the model human body explaining an example of the rehabilitation technique for the ankle joint and the toe joint of the lower extremity joint; and

FIG. 8 is a partial view of the model human body explaining an example of the rehabilitation technique for finger joints.

### DESCRIPTION OF THE PREFERRED EMBODIMENTS

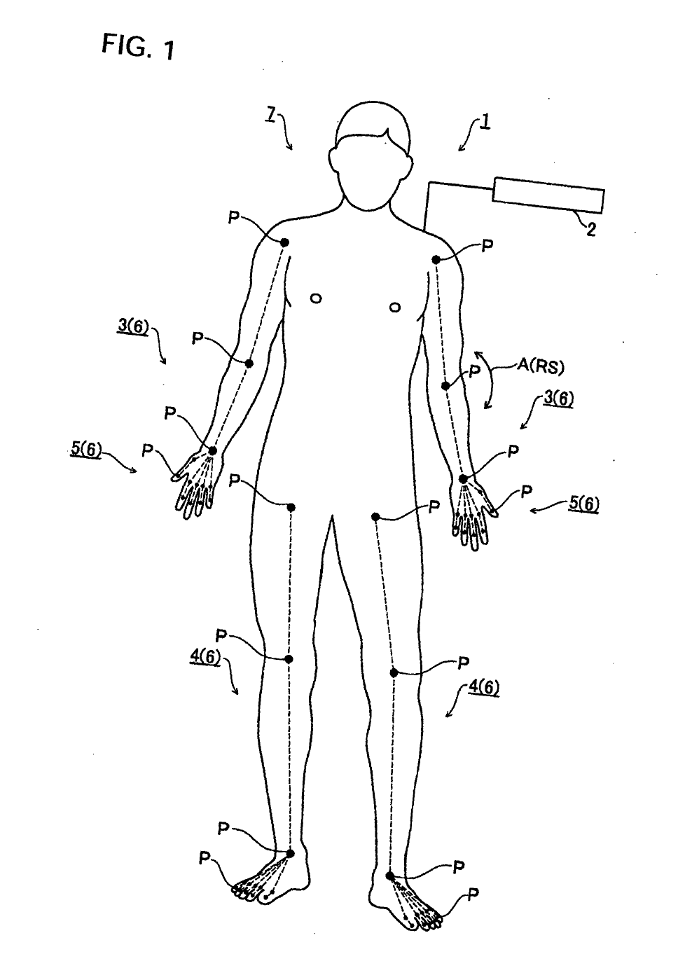

A physical rehabilitation training and education device 1 (hereinafter, a rehabilitation training device 1) will be explained with reference to FIGS. 1-8.

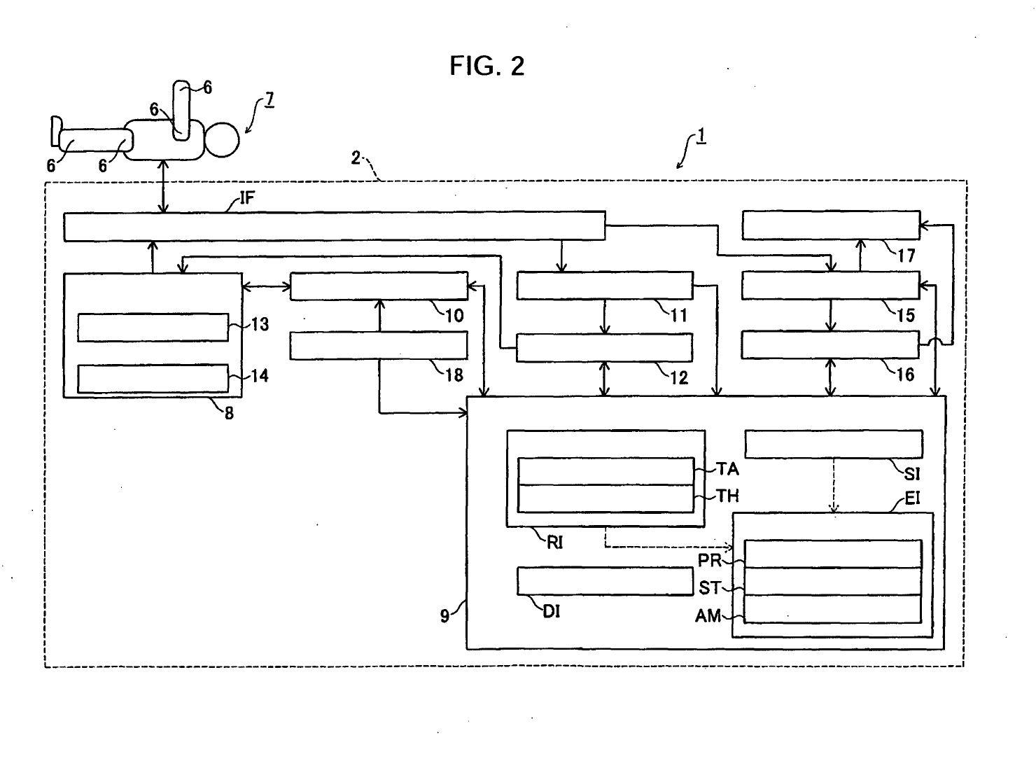

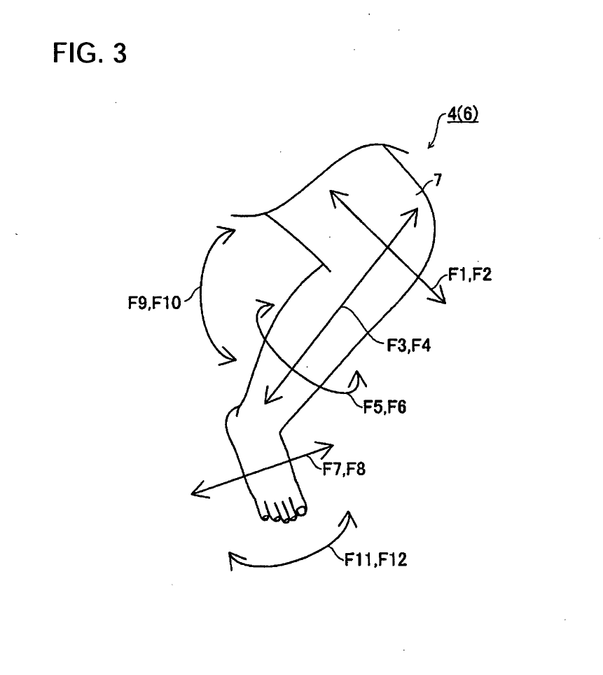

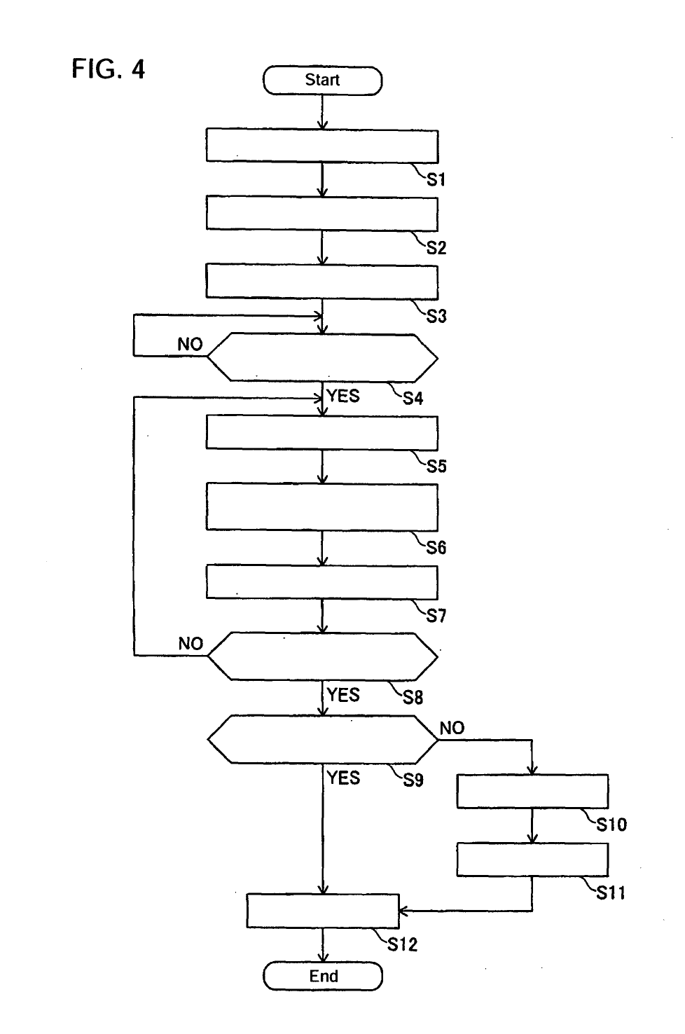

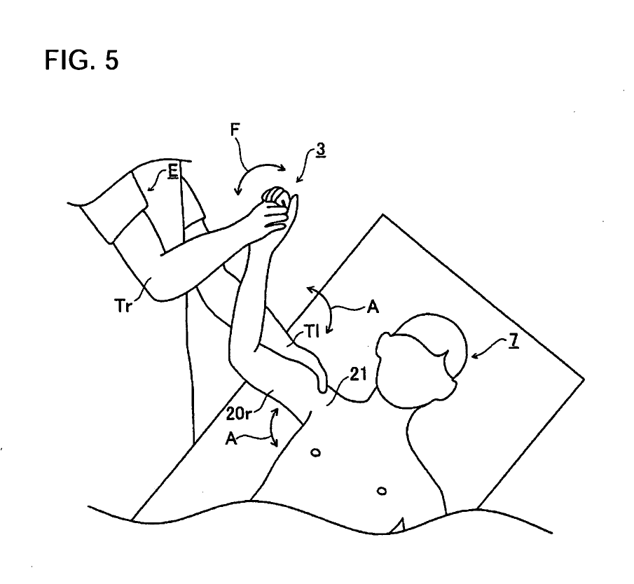

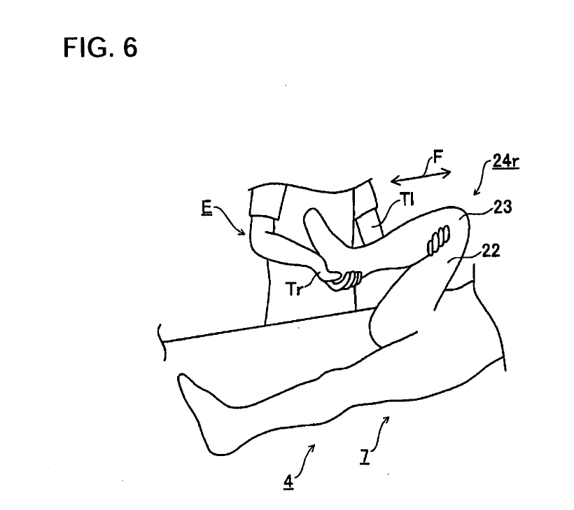

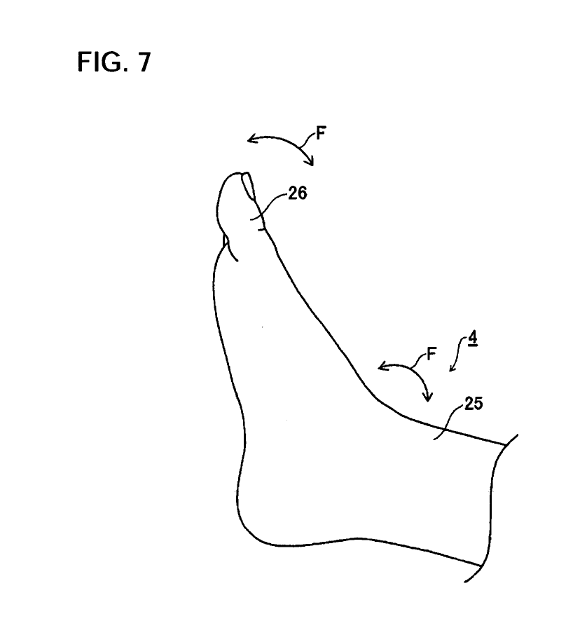

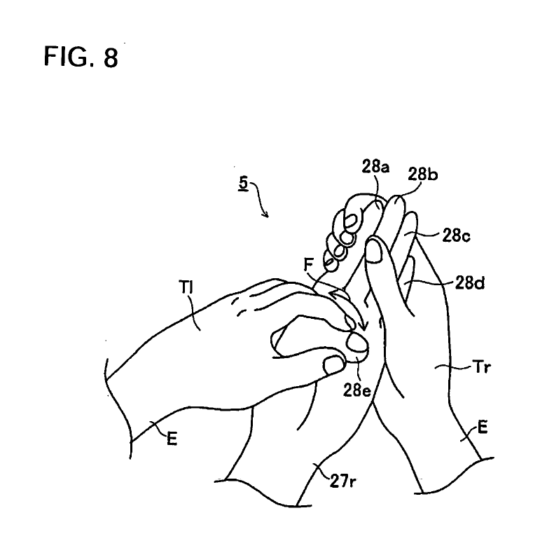

FIG. 1 is a schematic view of a structure of an embodiment of the rehabilitation training device 1. FIG. 2 is a flowchart mainly explaining the functional structure of the process controlling section 2 of the rehabilitation training device 1. FIG. 3 is a partial view of a model human body explaining an example of a simulated movement of a movable model joint 6. FIG. 4 is a flowchart explaining the process of controlling section 2 during the rehabilitation training of the rehabilitation training device 1. FIG. 5 is a partial view of the model human body explaining an example of a rehabilitation technique for an upper extremity joint 3. FIG. 6 is a partial view of the model human body explaining an example of the rehabilitation technique for articulation coxage and articulation genus of a lower extremity joint 4. FIG. 7 is a partial view of the model human body explaining an example of the rehabilitation technique for an ankle joint and a toe joint of the lower extremity joint. FIG. 8 is a partial view of the model human body explaining an example of the rehabilitation technique for finger joints 5.

As shown in FIGS. 1 and 2, the rehabilitation training device 1 of this embodiment is an imitated human body and is mainly composed of the model human body 7 and the process controlling section 2 performing various controls on the movable model joint 6 of the model 7. Here, the model human body 7 is comprised of the upper extremity section 3, capable of reproducing the movement of the joints at the upper extremity of the actual human body, the lower extremity section 4, capable of reproducing the movement of the joints at the lower extremity of the actual human body, and the finger section reproducing the movement of the joints at the fingers of the actual human body.

The process controlling section 2 will be explained with reference to FIG. 2. The process controlling section 2 mainly comprises the motion control section 8 which is connected with the model human body 7 via an interface IF and controls the movement of the movable model joint 6 of the model human body 7 based on various control signals; a memory section 9 storing and recording disease condition information DI which is the digitalized symptom of the joint condition that occurs to the human joint, such as dynamic contracture, static contracture, stiffness, and joint deformation; a joint condition reproduction section 10 displaying the simulated symptom of the condition at the movable model joint 6 based on the disease information DI recorded in the memory section and the motion control section 8 to reproduce the condition of disease; a section for obtaining information of rehabilitation technique 11 in which as the rehabilitation technique is performed by applying the repetitive external force onto the movable model joint 6 with the simulated condition displayed, the joint angle A, the joint position P, and rate of motion speed change RS regarding the movable model joint 6 which vary depending upon the types of the rehabilitation technique performed are measured and the resulting data is obtained as the information of the rehabilitation technique information RI; a section for controlling the improvement 12 controls to vary the simulated symptom of the joint condition at the movable model joint 6 according to the obtained information of the rehabilitation technique RI and displays the symptom representing the gradually improved condition.

The motion control section 8 is equivalent to the motion controller of the present invention; the joint condition reproduction section 10 is equivalent to the section to reproduce the condition of the present invention; the section for obtaining the information of the rehabilitation technique 11 is equivalent to the system to obtain the information of the rehabilitation technique of this invention; and the section for controlling the improvement 12 is equivalent to the condition improvement controller of this invention.

Further, the motion control section 8 of the rehabilitation training device 1 of this embodiment controls according to the motion range of the movable model joint 6 and the motion resistance equivalent to the reaction against the force applied at the rehabilitation technique so as to display the simulated symptom of the disease condition. Therefore, the motion control section 8 involves a motion range control section 13 for controlling the motion range and a motion resistance control section 14 for controlling the motion resistance. The motion range control section 13 is equivalent to the motion range controller of this invention; the motion resistance control section 14 is equivalent to the motion resistance controller of this invention.

In addition, the rehabilitation training device 1 of this embodiment has the memory section 9 that prerecords the rehabilitation technique information SI obtained through the performance of the rehabilitation technique on the actual patient for comparing with the rehabilitation technique information RI obtained at the section for obtaining the rehabilitation technique 11 in order to assimilate the simulated condition displayed based on the disease condition information DI and the simulated relaxed condition thereafter with the condition of the actual patient. In addition, the rehabilitation training device 1 of this embodiment, for the purpose of evaluating the level of the rehabilitation technique of the trainee, has information relating to evaluation criteria for medical treatment EI classifying the levels into the advanced level PR for a professional trainee, the intermediate level ST for a standard trainee, and an entry level AM for an amateur trainee, which is prerecorded in the memory section 9. The information relating to evaluation criteria for medical treatment EI is determined based on the second rehabilitation technique information SI obtained from the rehabilitation technique performed on the actual human body as described above and the information of the rehabilitation technique RI obtained from the rehabilitation technique performed on the movable model joint 6 as described above.

Then, information regarding the rehabilitation technique may be compiled from the obtained information of the rehabilitation technique RI and prerecorded second rehabilitation technique information SI. Accordingly, the information builds an evaluation data base for the rehabilitation technique performed according to the displayed condition. The rehabilitation training device 1 of this embodiment has an evaluation section 15 for an objective evaluation of the level of the rehabilitation technique at the rehabilitation training by means of utilizing the information relating to evaluation criteria for medical treatment EI having the data base build based on the obtained rehabilitation technique information RI and the second rehabilitation technique information SI.

Furthermore, the obtained rehabilitation technique information RI involves trainee attribute data TA relating to the trainee performing the rehabilitation technique and training history data TH containing the past training history (including the evaluation). The evaluation section 15 evaluates the level of performance, and a section for evaluating the improvement in the level of rehabilitation technique 16 compares the performance with the prior history to see if there is any improvement. A result reporting section 17 reports the trainee E in FIG. 5, via visual or hearing sense, the result obtained through the evaluation section 15 and the section for evaluating the improvement in the level of the rehabilitation technique 16. The evaluation section 15 is equivalent to an evaluation system of this invention; the section for evaluating the improvement in the level of the rehabilitation technique 16 is equivalent to the system to evaluate the improvement in the level of the rehabilitation technique of this invention; and a part of the result reporting section 17 is equivalent to the voice response system of this invention. An example of result reporting section 17 is, for example, to report to the trainee via the hearing sense using voice signals (not shown in the figures), about the fact that the rehabilitation technique performed on the model human body 7 was appropriate. On the other hand, when the trainee applying the rehabilitation technique applies an excessive load on the movable model joint 6, i.e., giving pain if applied on the actual patient, such a result is also reported via the hearing sense using the voice signals (not shown in the figures). Accordingly, the trainee can experience and judge about the degree of force that causes pain or no pain by means of utilizing the model human body 7, thereby offering more practical training.

The model human body 7 has its external surface coated with an artificial skin (not shown in the figures). FIG. 1 shows the joint position P and a broken line connecting the respective joint point P in order to represent the simulated position of the movable model joint 6. The movable model joint 6 is built with well-known robot technology, examples of which are an actuator, a hydraulic cylinder, a driving motor, and a universal joint (not shown in the figures) freely and displaceably connecting the respective frame. Furthermore, in order to obtain the rehabilitation technique information RI, the movable model joint 6 has measuring equipment (not shown in the figures) such as sensors and a rotary encoder for measuring the joint angle A, the joint point P, etc.

As shown in FIG. 3, an articulation genus of the lower extremity joint 4 of the rehabilitation training device 1 of this embodiment, for example, may be moved just like that of an actual human body. To explain more concretely, just like the actual human joint, the articulation genus of the lower extremity joint 4 is capable of making a protrusive movement F1 and setback F2, moving in the direction of an extremity axis juxtaposition) F3, moving in the distal direction F4, the abducens direction F5, and the incycloduction direction F6, moving outward F7 and inward F8, and moving in the bending direction F9, the extension direction F10, the extorsion direction F11, and the intorsion direction F12 as shown in different arrows in FIG. 3. Here, the rehabilitation training device 1 of this invention reproduces movements of the actual human joint in various directions by means of the movable model joint 6.

The process controlling section 2 of the rehabilitation training device 1 of this embodiment will be explained following an example process with reference to FIG. 4. To begin with a main switch (not shown in FIG. 4) of the rehabilitation training device 1 is turned on into an operating condition (S1). The desired disease condition on which the trainee wishes to perform the rehabilitation technique is selected by the trainee (not shown in FIG. 4) from the disease condition information DI recorded in the memory section 9, and the selection information is transferred to, and input in, an operating section 18 connected to the process controlling section 2. The process controlling section 2 receives the selection of the disease condition information DI via an input of the selection information (S2). Then, the motion controlling section 8 controls the movable model joint 6 based on the selected disease condition information Dl, thereby enabling to display the reproduction of the simulated condition of a patient with left half hemiplegia that resulted as a late effect of apoplectic stroke (S3). The above-described selection of the disease condition information DI may suggests the disease condition of the respective section of the body such as the upper extremity section 3, the lower extremity section 4, and the finger section 5 or the disease condition of the model body 7 as a whole such as left half hemiplegia.

The movable model joint 6 displays the symptom of the disease condition based on the information of the motion range and the motion resistance of the movable model joint 6. That is, generally, when the patient has decreased motion function due to such as hemiplegia, the joint motion become stiff and the muscle surrounding the joint becomes further stiff. Therefore, the respective joint is not capable of making a smooth movement and the motion range is highly restricted.

The motion range controlling section 13 and the motion resistance controlling section 14 express stiffness of the joint and muscle and the difficulties of bending each, thereby reproducing the simulated symptom of the disease condition such as the dynamic contracture of the joint. The trainee will have an opportunity to actually experience the symptom of the simulated disease condition by touching and feeling the movable model joint 6 with the reproduced symptom of the disease condition. That is, the trainee is able to procure practical knowledge as to the degree of the force necessary to perform appropriate rehabilitation through this experience.

Thereafter, the trainee with the experience of performing the rehabilitation on the symptom of the simulated diseased condition performs the rehabilitation technique on the movable model joint 6. At that time, the section for obtaining the rehabilitation technique information 11 provided in the rehabilitation training device 1 detects the existence of any rehabilitation technique information RI with regard to the movable model joint 6 changing as the trainee performs the rehabilitation technique (S4). The rehabilitation technique information RI obtained herein involves the movable range R of the movable model joint 6 changed by the external force against the motion resistance provided, the joint angle A, the joint position P, and the rate of change RS representing the amount of change per unit-time.

Obtaining the rehabilitation technique information RI means that the force according to the rehabilitation technique of the movable model joint with the disease condition is displayed, thereby exercising the movable model joint 6 in response to the force applied based on the rehabilitation technique (S5). Thereafter, according to the obtained rehabilitation technique information RI, the improvement controlling section 12 determines the degree of the improvement of the symptom of the disease condition displayed (S6), and the movable model joint 6 is controlled or adjusted to reflect the improved state, based on the determination (S7).

In the case of performing the rehabilitation on an actual patient, an excessive load or force applied to the joint of the patient could damage the joint function rather than provide recovery of the same, which results in delayed recovery. In consideration of the therapeutic effect, to avoid further damage of the joint of the patient, the rehabilitation technique is performed by gradually applying the external force to the joint with sufficient time so as to relax the stiffness of the joint and to gradually expand the motion range.

In the rehabilitation training device 1 of this embodiment, by means of the above-described motion range controlling section 13 and the motion resistance controlling section 14, the movable model joint 6 is controlled while releasing the restriction or limitation of the motion range and reducing the motion resistance value according to the obtained rehabilitation technique information RI. Accordingly, the condition as relaxing or modifying the severity of the symptom of the simulated disease condition is displayed in response to the performed rehabilitation technique.

In the case that the rehabilitation technique information RI is continuously being recognized and obtained (No at S8), the rehabilitation training device 1 goes back to S5 to continue exercising of the movable model joint 6 and then displaying the improved state of the simulated symptom.

As a result, by repeating the rehabilitation technique training on the movable model joint 6, the trainee enjoys the feeling of rehabilitation as if performing on the actual patient and is able to learn the rehabilitation technique of the rehabilitation training. On the other hand, if the rehabilitation technique is completed (Yes at S8), the process of obtaining the rehabilitation technique information RI is ceased and the process shifts to S9. In addition, the rehabilitation training device 1 of this embodiment gives an objective evaluation of the level of the rehabilitation technique of the trainee as described above. The process proceeds to find the command for evaluation after performing the rehabilitation technique (S9). If no command for the evaluation is found (Yes at S9), the rehabilitation training device 1 stops its operation and the rehabilitation technique training is ceased (S12). On the other hand, if the command for evaluation is found (No at S9), evaluation for the particular rehabilitation technique level such as the advanced level PR based on the information relating to evaluation criteria for the medical treatment EI (S10), and the result of the evaluation is reported to the trainee E. This evaluation includes an evaluation for the degree of improvement in the rehabilitation technique level based on the trainee attribute data TA and training history data performing the rehabilitation technique TH for the trainee E.

The information relating to evaluation criteria for the medical treatment EI used for this evaluation is digitalization of the second rehabilitation technique information SI obtained through the rehabilitation technique performed on the actual patient by therapists of various levels and the rehabilitation technique information RI obtained through the rehabilitation technique simulation performed on the rehabilitation training device 1 of this embodiment. That is, the evaluation of the rehabilitation technique through the rehabilitation training device 1 of this invention becomes more accurate by accumulating the rehabilitation technique performed on the actual patient by professional therapists with sophisticated rehabilitation technique and the rehabilitation technique performed on the movable model joint 6 with the reproduced symptom of the simulated disease condition by the professional therapist.

According to the rehabilitation training device 1 of this embodiment, as is described above, the degree of improvement in the level of the rehabilitation technique may clearly be proved from the past record based on the trainee attribute data TA and the training history data by the trainee who performed the rehabilitation technique TH. That is, the trainee E can improve the rehabilitation technique level by repeating the rehabilitation training numerous times. The rehabilitation technique information RI received includes the trainee attribute data TA of the trainee with at least one training and the training history data performing the rehabilitation technique TA. As a result, the evaluation of the rehabilitation technique is evaluated in comparison with the training history data of the trainee E.

Then, one example of the rehabilitation training utilizing the rehabilitation training device 1 of this embodiment will be explained with reference to FIGS. 4-8. The model human body 7 of the rehabilitation training device 1 of this embodiment has the upper extremity joint section 3, the lower extremity joint section 4, and the finger joint sections 5 as the movable model joint 6. To explain more concretely, the upper extremity joint section 3 mainly suggests a shoulder joint and elbow and is able to move an upper arm and elbow just like the actual human body. The lower extremity joint section 4 mainly suggests articulation coxae, knee, ankle, and toe and moves an extremity just like the actual human body. The finger joint section 5 suggests a section after a wrist toward the end of the arm and is able to control in order to reproduce movements of a thumb, a forefinger, a middle finger, a ring finger, a fifth finger (movements of the first, second, third joints), the angle of the wrist, and an action of gripping with fingers.

An example of the rehabilitation technique as to each of the movable model joints 3, 4, and 5 will be explained next. For example, regarding the upper extremity joint section 3 as shown in FIG. 5, the trainee E takes a right hand 20r of the model human body 7 with a right hand Tr to slowly move in the direction of the arrow F in FIG. 5 while holding the right shoulder joint 21. This action moves an upper arm with the right shoulder joint 21 as fulcrum. Extension of the elbow may be conducted simultaneously. At that time, the dynamic contracture occurring to the right shoulder joint 21 is reproduced on the upper extremity joint section 3 by the joint condition reproduction section 10 and the motion controlling section 8 (including motion range controlling section 13 and the motion resistance controlling section 14). Accordingly, under the condition reproduced herein a simple attempt of moving the right shoulder joint 21 cannot easily be accomplished because of the motion reaction.

Therefore, when the trainee E is performing the rehabilitation technique as above, a force greater than the controlled motion resistance needs to be applied on the upper extremity joint section 3. At that time, the section for obtaining the rehabilitation technique 11 connected to the upper extremity joint section 3 measures the joint angle A of the respective upper extremity joint section 3 (e.g., an upper arm angle and an elbow angle relative to the body), the joint position P, and the rate of change RS calculated in consideration of the duration of the applied force and the amount of joint change, which is obtained as the rehabilitation technique information RI. Thereafter, if the movement in the direction of the arrow is repeated then the improvement controlling section 12 reduces the motion range and the motion resistance of the upper extremity joint section 3 and act as a control to help smooth improvement in the symptom of the disease condition. As a result, the motion range of the right shoulder joint 21 of a higher joint extremity 3 is expanded, and reducing the motion resistance allows the trainee E to move thereof smoothly as performing the rehabilitation technique. That is, a condition of healthy right shoulder joint 21 is reproduced, which provides the trainee E an experience of the rehabilitation technique simulation.

As shown in FIG. 6, in the case of rehabilitating the extremity joint 22 and the knee 23 of the lower extremity joint section 4, the trainee E holds the right foot 24r immediately below the knee 23 of the model human body 7 with the left hand T1 and holds a hock of the right foot 24r of the model human body 7 with the right hand Tr, thereby retaining the right foot 24 with both hands. Then, the rehabilitation technique is performed by applying force in the direction of the arrow F. Accordingly, the trainee E views the displayed symptom of the condition of the lower extremity joint section 4 and can experience the rehabilitation technique performed thereon. Operation and effect of the rehabilitation technique should be the same as the above-described upper extremity joint section 3; therefore, the explanation of which is omitted here. Further, similarly, the lower extremity joint section 4 of the model human body 7 of the rehabilitation training device 1 in this embodiment is designed such that the ankle 25 and the toe 26 positioned lower than the knee 22 are also able to make a motion. Therefore, the trainee E is able to experience the simulation of the rehabilitation technique relative to the ankle 25 and the toe 26 as applying the force thereon in the direction of the arrow F in FIG. 7.

In addition, the trainee uses the rehabilitation training device 1 to experience the simulation of the rehabilitation technique relative to the finger joint 5 of the model human body 7. More concretely, as shown in FIG. 8, for example, the trainee E holds the forefinger 28a, the middle finger 28b, the ring finger 28c, and the fifth finger of the right hand 27r of the model human body 7 with the right hand Tr of the trainee and holds the thumb 28e of the right hand Tr with the left hand T1 of the trainee E. Then, the rehabilitation techniques are performed by applying force in the direction of the arrow in FIG. 8. Accordingly, the trainee E can experience the simulation of the rehabilitation technique to recover the function of the thumb joint 23e.

As described above, according to the rehabilitation training device 1 of this embodiment, the trainee E is able to experience the simulation of the symptom of the disease condition displayed on the movable model joint 6 (including the upper extremity joint section 3, the lower extremity joint section 4, and the finger joint section 5). Furthermore, performing the rehabilitation technique on the movable model joint 6 resembles performance of the same on the actual patient where the movable model joint 6 reproduces the symptom of the improved disease condition. Therefore, the trainee E can use the rehabilitation training device 1 of this embodiment to experience the simulation of the rehabilitation technique performed on the model human body 7. In addition, this rehabilitation training device 1 can provide objective evaluation of the rehabilitation technique performed on the model human body 7 based on the information relating to evaluation criteria for medical treatment EI, and the trainee E can recognize the improvement of the rehabilitation technique level based on the training history data performing the rehabilitation technique TH.

Accordingly, the use of the rehabilitation training device 1 of this embodiment is not limited to an amateur trainee in the entry level but is open to the standard or professional trainee with relatively sufficient experiences for reconfirming the rehabilitation technique based on the fundamental skills that the device 1 can provide. That is, abnormal behavior or improper manipulation acquired from the actual experiences of the rehabilitation technique may be recognized and redressed through the device 1.

The rehabilitation training device 1 of this invention has been explained with reference to preferable embodiments so far. While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

That is, in the rehabilitation training device 1 of this embodiment, the movable model joint 6 capable of reproducing the symptom of the disease condition may be provided at every section of the model human body 7, i.e., the upper extremity, the lower extremity, and fingers. However, the structure is not limited to this type and the movable model joint 6 may be provided only at the applicable limited sections for the training such as the finger joints.

Further, as the model human body 7, the embodiments above have the entire figure of the body. However, the structure is not limited to this type and the model human body 7 may be limited to the applicable sections for training such as the upper extremity, the lower extremity, and the fingers. Modification as such may have advantages of assemblability, transferability, and storagability. Modeling the entire figure as above enables the model human body 7 to display the simulated condition of hemiplegia due to the apoplectic stroke.

That is, in the case where joint contracture occurred at the upper extremity, the lower extremity, and the fingers of a half body (e.g., right half body), the trainee performs the rehabilitation technique on the upper extremity joint section 3, the lower extremity joint section 4, and the finger joint section 5 respectively and may confirm the symptom of improving the condition of the respective section. Therefore, the trainee is able to experience very practical and realistic simulation and is able to rapidly improve the level of the rehabilitation technique.

1. A physical rehabilitation training and education device, comprising:
a model human body imitating a human body with one or more movable model joints imitating movement of a real human joint;
a motion controller that controls movement of the movable model joint;
a joint condition information memory system for storing information relating to the joint condition of said human joint; and
a joint condition display that shows simulated symptoms of said joint condition of the movable model joint while the motion controller controlling said motion controller based on the stored joint condition information.

2. The physical rehabilitation training and education device according to claim 1, further comprising:
a rehabilitation technique information system that obtains rehabilitation technique information when rehabilitation is performed by a trainee while said trainee is applying an external repetitive force to the movable model joint with a joint condition, said joint condition is displayed thereon by the joint condition displayer, said system measures a rate of change of the joint condition based on an angle, a position, and a motion speed of the movable model joint due to said external repetitive force being applied thereon by the trainee; and
a joint condition improvement controller that is capable of displaying a simulated diagnosis of a rehabilitating symptom regarding said movable model joint and is capable of controlling the progress of the simulated condition based on the rehabilitation technique information obtained from the trainee as the trainee performs said rehabilitation technique on said movable model joint.

3. The physical rehabilitation training and education device according to claim 1, said motion controller further comprising:
a motion range controller that controls a motion range of the movable model joint; and
a motion resistance controller that controls a motion resistance where said reaction force is equivalent to a reaction force against said external repetitive force on the movable model joint.

4. The physical rehabilitation training and education device according to claim 2, said motion controller further comprising:
a motion range controller that controls a motion range of the movable model joint; and
a motion resistance controller that controls a motion resistance where said reaction force is equivalent to a reaction force against said external repetitive force on the movable model joint.

5. The physical rehabilitation training and education device according to claim 2, further comprising:
a secondary rehabilitation technique information memory that stores the secondary rehabilitation technique information showing changes in the movable model joint after performing the rehabilitation technique on the human body.

6. The physical rehabilitation training and education device according to claim 3, further comprising:
a secondary rehabilitation technique information memory that stores the secondary rehabilitation technique information showing changes in the movable model joint after performing the rehabilitation technique on the human body.

7. The physical rehabilitation training and education device according to claim 4, further comprising:
a secondary rehabilitation technique information memory that stores the secondary rehabilitation technique information showing changes in the movable model joint after performing the rehabilitation technique on the human body.

8. The physical rehabilitation training and education device according to claim 2, further comprising:
an evaluation criteria information memory system that stores information of evaluation criteria where said trainee is evaluated based on a pre-established criteria for medical treatment classified by one or more levels of rehabilitation technique so as to evaluate the trainee based on the level of rehabilitation technique performed; and
an evaluation system that evaluates the level of rehabilitation technique performed by the trainee based on the rehabilitation technique information and said evaluation criteria information for medical treatment.

9. The physical rehabilitation training and education device according to claim 3, further comprising:
an evaluation criteria information memory system that stores information of evaluation criteria where said trainee is evaluated based on a pre-established criteria for medical treatment classified by one or more levels of rehabilitation technique so as to evaluate the trainee based on the level of rehabilitation technique performed; and
an evaluation system that evaluates the level of rehabilitation technique performed by the trainee based on the rehabilitation technique information and said evaluation criteria information for medical treatment.

10. The physical rehabilitation training and education device according to claim 4, further comprising:
an evaluation criteria information memory system that stores information of evaluation criteria where said trainee is evaluated based on a pre-established criteria for medical treatment classified by one or more levels of rehabilitation technique so as to evaluate the trainee based on the level of rehabilitation technique performed; and
an evaluation system that evaluates the level of rehabilitation technique performed by the trainee based on the rehabilitation technique information and said evaluation criteria information for medical treatment.

11. The physical rehabilitation training and education device according to claim 2, wherein
said rehabilitation technique information includes trainee attribute data and training history data for the particular trainee performing the rehabilitation technique; and
said evaluation system has a system to evaluate any improvement in the level of rehabilitation technique regarding said trainee based on training history data.

12. The physical rehabilitation training and education device according to claim 3, wherein
said rehabilitation technique information includes trainee attribute data and training history data for the particular trainee performing the rehabilitation technique; and
said evaluation system has a system to evaluate any improvement in the level of rehabilitation technique regarding said trainee based on training history data.

13. The physical rehabilitation training and education device according to claim 4, wherein
said rehabilitation technique information includes trainee attribute data and training history data for the particular trainee performing the rehabilitation technique; and
said evaluation system has a system to evaluate any improvement in the level of rehabilitation technique regarding said trainee based on training history data.

14. The physical rehabilitation training and education device according to claim 8, wherein
said information of the evaluation criteria for the medical treatment is classified into an amateur level for a beginning trainee, a standard level for a trainee with a predetermined level of skills and experiences, and a professional level for a highly skilled and experienced trainee.

15. The physical rehabilitation training and education device according to claim 11, wherein
said information of the evaluation criteria for the medical treatment is classified into an amateur level for a beginning trainee, a standard level for a trainee with a predetermined level of skills and experiences, and a professional level for a highly skilled and experienced trainee.

16. The physical rehabilitation training and education device according to claim 8,
said evaluation system further comprises a voice response system to output an audible signal to report a load being applied on the movable model joint based on the rehabilitation technique information.

17. The physical rehabilitation training and education device according to claim 11,
said evaluation system further comprises a voice response system to output an audible signal to report a load being applied on the movable model joint based on the rehabilitation technique information.

18. The physical rehabilitation training and education device according to claim 1, wherein
said movable model joint has at least one of an upper extremity section, a lower extremity section, and a digit section.

19. The physical rehabilitation training and education device according to claim 2, wherein
said movable model joint has at least one of an upper extremity section, a lower extremity section, and a digit section.

20. The physical rehabilitation training and education device according to claim 3, wherein
said movable model joint has at least one of an upper extremity section, a lower extremity section, and a digit section.

21. The physical rehabilitation training and education device according to claim 4, wherein
said movable model joint has at least one of an upper extremity section, a lower extremity section, and a digit section.

22. The physical rehabilitation training and education device according to claim 1, wherein
the simulated condition of the movable model joint exhibits symptoms of at least one of dynamic contracture, static contracture, stiffness, and joint deformation.

23. The physical rehabilitation training and education device according to claim 2, wherein
the simulated condition of the movable model joint exhibits symptoms of at least one of dynamic contracture, static contracture, stiffness, and joint deformation.

24. The physical rehabilitation training and education device according to claim 3, wherein
the simulated condition of the movable model joint exhibits symptoms of at least one of dynamic contracture, static contracture, stiffness, and joint deformation.

25. The physical rehabilitation training and education device according to claim 4, wherein
the simulated condition of the movable model joint exhibits symptoms of at least one of dynamic contracture, static contracture, stiffness, and joint deformation.
